(19) United States
(12) Patent Application Publication
(10) Pub. No.: US 2024/0165840 A1
(43) Pub. Date: May 23, 2024

(54) CUTTING DEVICE FOR CUTTING CAPSULES

(71) Applicant: SACMI COOPERATIVA MECCANICI IMOLA SOCIETA’ COOPERATIVA, Imola (BO) (IT)

(72) Inventors: Matteo VENTURINI, Imola (BO) (IT); Vittorio BASSI, Faenza (RA) (IT)

(21) Appl. No.: 18/551,622

(22) PCT Filed: Mar. 24, 2022
(86) PCT No.: PCT/IB2022/052702

§ 371 Date: Sep. 21, 2023

(30) Foreign Application Priority Data
Mar. 25, 2021 (IT) 102021000007262

(51) Int. Cl. B26D 3/08; B26D 1/00; B26D 1/02

(52) U.S. Cl. CPC B26D 3/08; B26D 1/0006; B26D 1/02; B26D 2001/006

(57) ABSTRACT

Cutting device to form on a capsule for closing a container at least one connecting strap that keeps the capsule attached to the container after opening, the cutting, device comprising at least one cutting edge to make at least one cut on the capsule, the at least one cutting edge comprising a cutting start capsule inlet, a cutting end capsule outlet, and at least one transition cutting portion arranged on the capsule inlet and/or on the capsule outlet to form at least one cusp-shaped end zone, the at least one cutting portion being retracted with respect to a remaining part of the at least one cutting, edge so as to penetrate less the capsule of a remaining part of the at least one cutting edge reducing stress concentration and preventing initiation of a fracture in the at least one cusp-shaped end zone.

The invention relates to a cutting device for cutting or notching capsules or closures or caps made of plastics of the type used to close containers, such as for example bottles. In particular the invention relates to a cutting device arranged for cutting a so-called tethered capsule, or for cutting the side wall of a capsule so as to obtain on the side wall a tamperproof band or ring and one or more connecting portions, also known as straps or strips, which connect the tamperproof band or ring to a different portion of the capsule, for example to the main body of the capsule, i.e. to a portion of the side wall having a closed end of the capsule.

In particular, these connecting straps enable the main body to be maintained of the capsule attached to the tamperproof ring also after the container has been opened so as not to accidentally disperse the capsule in the environment.

For such capsules, the various blades are generally arranged separated from one another on one or more levels. Such blades generally have a limited angular extension, i.e. a revolution of less than 360° of the capsule. In other words, in particular to make connecting portions like straps, the blades make distinct and separate cuts so as to prevent total separation of the main body of the capsule from the tamperproof ring, once the capsule is removed from the container to which it is applied.

Cutting apparatuses are known with a carousel structure that rotates a plurality of spindles, each rotating on itself, fitted to the periphery of the carousel. Each spindle is arranged for taking a capsule, rotating the capsule on itself and moving the capsule along a circular advancement path through one or more cutting zones of the capsule, where at least one cutting device is arranged that cuts or notches the side wall of the capsule.

Known prior art cutting devices comprise cutting edges arranged for penetrating a thickness of said capsule in order to make cuts that generate the straps in the capsule. The cuts end on the capsule with a cusp.

The cusp made (capsule side) by known cutting devices has the drawback caused by the sharpened conformation thereof of being a source of concentration of tensions and contributes, together with the notch effect due to the sudden change of section between the ring (or equivalently, between the body of the capsule) and the strap, weakening the mechanical resistance of the strap and the capsule in general. This means that by removing the capsule from the ring a fracture is triggered that originates from the tip of the cusp and continues in the material of the capsule, damaging the strap until it is broken, thus losing the function of connection between tamperproof ring and main body of the capsule.

The poor resistance of the straps entails both a fall in productivity, increasing production waste and costs, and poor quality of the produced capsule.

### SUMMARY OF THE INVENTION

One object of the invention is to improve known cutting devices for cutting capsules.

One object is to provide a device that is able to solve one or more of the aforesaid limits and drawbacks of the prior art.

One object is to provide a device for cutting capsules that is alternative to those of the prior art.

One object is to provide a device for cutting capsules limiting the weakening of the capsules at cuts, in particular in cutting zones for generating straps.

One advantage is to improve cutting quality, in particular to notch tethered capsules.

One advantage of the invention is to ensure cutting that limits concentration of stress at the cuts, in particular in cutting zones for generating straps.

One advantage is to make available a cutting device for notching capsules that is constructionally simple and cheap.

Another advantage is to reduce waste in the production of capsules provided with notches.

Such objects and advantages and still others, are achieved by a device according to one or more of the following claims.

In one embodiment, a cutting device for forming, on a capsule closing a container, at least one connecting strap to keep the capsule attached to said container after opening, comprises at least one cutting edge configured to perform the at least one cut on the capsule, the capsule rolling on the at least one blade during performance of at least one cut, with a cut start and a cut end that are suitable for forming at least one part of the at least one connecting strap, the at least one cutting edge being provided with a capsule inlet, where the capsule meets the at least one cutting edge to start the at least one cut, and with a capsule outlet, where the capsule leaves the at least one cutting edge to end the at least one cut, the at least one cutting edge comprising at least one transition cutting portion arranged on the capsule inlet and/or on the capsule outlet to form at least one cusp-shaped end zone at the cut start and/or the cut end, the at least one transition cutting portion being retracted with respect to a remaining part of the at least one cutting edge so as to penetrate less one thickness of the capsule with respect to the remaining part of the at least one cutting edge so as to reduce the stress concentration and discourage the triggering of a fracture in the at least one cusp-shaped end zone.

In one embodiment, a cutting device to form on a capsule for closing a container with at least one connecting strap that keeps the capsule attached to the container after opening, comprises at least one cutting edge to make at least one cut on the capsule. The at least one cutting edge comprises a cut start capsule inlet, a cut end capsule outlet, and at least one transition cutting portion arranged on the capsule inlet and/or on the capsule outlet to form at least one cusp-shaped end zone, the at least one cutting portion being retracted with respect to a remaining part of the at least one cutting edge so as to provide a step between the at least one transition cutting portion and the remaining part of the at least one cutting edge so as to penetrate less the capsule of a remaining part of the at least one cutting edge reducing stress concentration and discouraging the triggering of a fracture in the at least one cusp-shaped end zone.

In one embodiment, a cutting device to form on a capsule for closing a container with at least one connecting strap that keeps the capsule attached to the container after opening, comprises at least one cutting edge to make at least one cut on the capsule. The at least one cutting edge comprises a cut start capsule inlet, a cut end capsule outlet, and at least one transition cutting portion arranged on the capsule inlet and/or on the capsule outlet to form at least one cusp-shaped end zone, the at least one cutting portion being retracted with respect to a remaining part of the at least one cutting edge so as to penetrate less the capsule of a remaining part of the at least one cutting edge reducing stress concentration and discouraging the triggering of a fracture in the at least one cusp-shaped end zone.

### SHORT DESCRIPTION OF THE DRAWINGS

The invention can be better understood and implemented with reference to the enclosed drawings that illustrate some embodiments thereof by way of non-limiting example, in which:

FIG. 1 is a top view of a cutting edge according to a first embodiment of a device for cutting capsules;

FIG. 2 is a through section for a plane II indicated in FIG. 1, which illustrates a cross section of a transition cutting portion;

FIG. 3 is a first detail of the cutting edge of FIG. 1;

FIG. 4 is a second detail indicated by iv in FIG. 1 that shows a recess in the cutting edge for forming a bridge;

FIG. 5 is a top view of a cutting edge according to a version of the first embodiment;

FIG. 6 is a detail of the cutting edge of FIG. 5;

FIG. 7 is a top view of a cutting edge according to a second embodiment of a device for cutting capsules;

FIG. 8 is a through section for a plane VIII indicated in FIG. 7, which illustrates a cross section of a transition cutting portion;

FIG. 9 is a detail of the cutting edge of FIG. 7;

FIG. 10 is a top view of a cutting edge according to a version of the second embodiment of the device for cutting capsules of FIG. 7;

FIG. 11 is a detail of the cutting edge of FIG. 10;

FIG. 12 is a top view of a cutting edge according to a third embodiment of a device for cutting capsules;

FIG. 13 is a through section for a plane XIII indicated in FIG. 12, that illustrates a section of a transition cutting portion;

FIG. 14 is a detail of the blade of FIG. 12;

FIG. 15 is a side view of a tethered capsule of the type makeable by an arrangement of cutting edges according to the invention in which cusp end zones are shown for generating connecting straps;

FIG. 16 is a perspective view of a part of a cutting apparatus in which the cutting device according to the invention is indicated;

FIG. 17 is a schematic top view of a cutting apparatus comprising a carousel and in which a cutting zone is shown in which the cutting device according to the invention is arranged;

FIG. 18 is a top view of a cutting edge according to a fourth embodiment of a device for cutting a cap;

FIG. 19 is a partial perspective view of the cutting edge of FIG. 18 showing a transition cutting portion which is rounded;

FIG. 20 is a partial front view of the cutting device of FIG. 18;

FIG. 21 is a through section for a plane XXI indicated in FIG. 18, that shows the transition cutting portion;

FIG. 22 is a schematic view of cutting edges of a cutting device comprising at least one cutting edge as in FIG. 18;

FIG. 23 is a schematic side view of a tethered capsule—unrolled in a reference plane—of the type makeable by the cutting device of FIG. 22 in which cusp end zones are shown for generating connecting straps.

### DETAILED DESCRIPTION

With respect to the figures mentioned above, a cutting device 1 for cutting or notching a cap or a capsule 2 is disclosed. The capsule 2 is usable, in particular, as a closure of a container, such as a bottle.

In particular, the cutting device 1 is used for cutting a capsule 2 provided with at least one connecting strap, a so-called tethered capsule, suitable for maintaining the capsule 2 attached to the container after opening of the container.

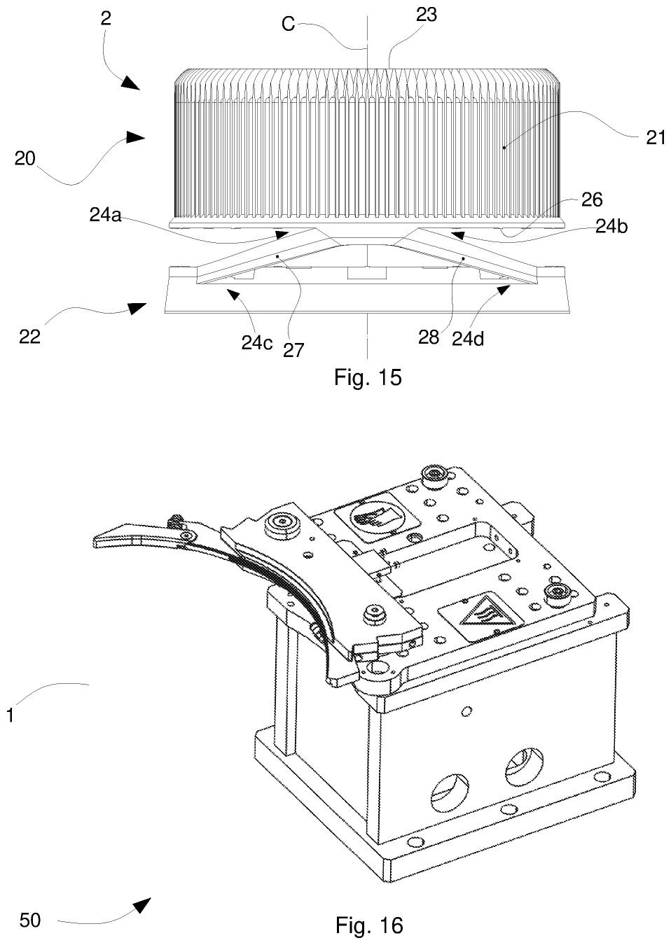

With reference to FIG. 15, in which an explanatory but non-limiting embodiment is disclosed of a capsule 2 cut by the device 1 according to the invention, the capsule 2 comprises, in particular, a cup body with a base wall 23 that defines a closed end of the cup body and an open annular end opposite the base wall 23.

The base wall 23 can be in particular disc-shaped and can comprise a central region traversed by a longitudinal axis C that can be transverse, in particular orthogonal, to the base wall 23 and a peripheral region near a peripheral edge of the disc and further from the longitudinal axis C with respect to the central region. The capsule 2 can comprise, in particular, a side wall 21 that is contiguous with the base wall 23 that extends from the peripheral region of the base wall 23 around the longitudinal axis C of the capsule 2 as far as a free edge of the side wall 21 that defines the annular end of the cup body.

The capsule 2 can comprise, in particular, a plurality of cuts that defines a plurality of facilitated fracture lines, or weakening lines. The plurality of cuts comprises at least one cut, each of which can be arranged on the capsule 2 according to a tilt with respect to the longitudinal axis C, in particular, the at least one cut can form an acute, or obtuse, or flat or right angle with the longitudinal axis C. The plurality of cuts can define on the capsule 2 a main body 20, a tamperproof ring 22 and at least one connecting strap 27, 28 that connects the main body 20 to the tamperproof ring 22. In particular, the main body 20 comprises the closed end of the cup body, the tamperproof ring 22 comprises the open annular end of the cup body of the capsule 2.

The at least one cut is provided with a cut start, i.e. a start end, and with a cut end, i.e. a final end. The cut start and the cut end are suitable, in particular, for forming at least one part of the at least one connecting strap 27, 28.

At one cut end, i.e. the start and/or the end of the cut, at least one cusp-shaped end zone 24a, 24b, 24c, 24d is formed that generates one part of the at least one strap 27, 28. In other words, at the cut end the penetration of a cut edge of the device generates a sudden narrowing of a section of the capsule 2 having a tip or cusp shape. The end (capsule side) of the cusp end 24a, 24b, 24c, 24d zone through the confirmation thereof is a source of concentration of the stress inside the material of capsule 2. This stress can increase in particular when the capsule 2 is subjected to force acting from the outside, for example when the main body 20 is moved away from the tamperproof ring 22. This occurs when a user opens the container to which the capsule 2 is applied or during movement of the capsule 2 inside a capsule 2 machining apparatus. The concentration of the stress can trigger a fracture that originates from the end of the cusp and continues inside the side wall 21 causing breakage of the at least one strap 27, 28 and/or damage to other portions of the capsule 2.

In the specific embodiment of FIG. 15, two upper cusp end zones 24a, 24b are defined at a cut end in relation to a portion joining the connecting straps 27, 28 and the main body 20 and two lower cusp end zones 24c, 24d in relation to a portion joining the connecting straps 27, 28 and the tamperproof ring 22.

In the specific embodiment of FIG. 15 the capsule 2 is provided with two straps having tilts that are opposite in particular the longitudinal axis C of the capsule 2.

The cutting device 1 can notch tethered capsules that are different from that illustrated in FIG. 15, in particular, the cutting device 1 according to the invention can cut capsules provided in particular with a single strap arranged according to any tilt, or two straps arranged with concordant tilts, with respect to the longitudinal axis C (opposite the illustrated straps 27, 28) or with tilts that are different from one another. Alternatively, the cutting device 1 can cut capsules for forming three straps, in which each strap can have any tilt with respect to the longitudinal axis of the capsule.

The number and the specific conformation of the strap/s depend on an arrangement of cutting edges of the cutting device 1.

The cutting device 1 can be fitted in a cutting apparatus 100 for cutting a capsule 2, in particular for cutting a tethered capsule.

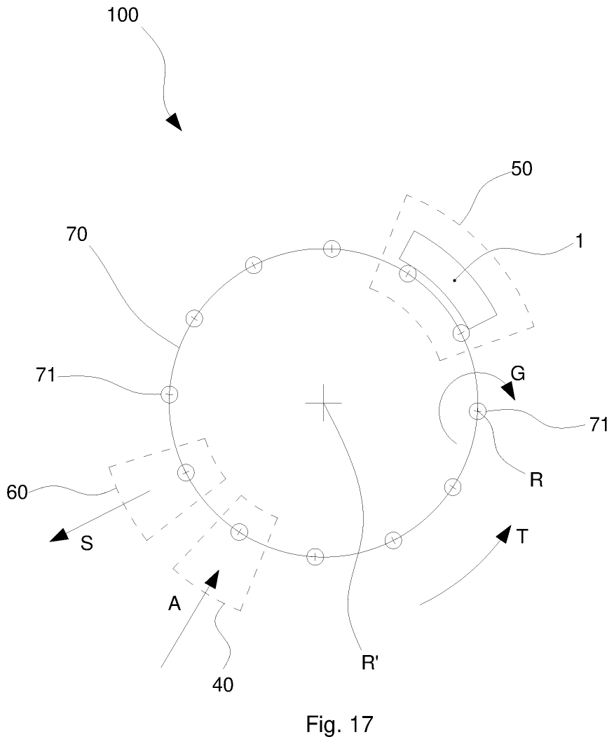

With reference to FIGS. 16 and 17, the cutting apparatus 100 comprises, in particular, a carousel structure, or capsule movement carousel 70 that rotates around a revolution axis R′ thereof. The carousel 70 comprises a plurality of spindles 71 fitted angularly spaced apart on the periphery of the carousel 70, where “angularly” is intended with respect to the revolution axis R′. Each spindle 71 can rotate around a rotation axis R thereof and is arranged to engage the capsule 2 to rotate the capsule 2 on itself and convey the capsule 2 along an advancement path through various zones.

The advancement path of the capsule 2 extends at least partially along a circumferential arc defined by the carousel 70.

The cutting apparatus 100 can comprise, in particular, a feeding zone 40 in which the capsule 2 is fed according to the feeding direction A entering the carousel 70. The feeding zone 40 can be positioned downstream of a preceding machining zone (not shown) from which the capsule 2 originates, like for example a forming zone in which capsule 2 is moulded.

The cutting apparatus 100 comprises, in particular, a cutting zone 50 positioned downstream of the feeding zone 40 in which cutting zone 50 the capsule 2 is cut. In the cutting zone 50, one or more cutting devices can be positioned to notch the capsule 2, for forming the cuts and fracture lines on the capsule, in particular, a cutting device 1 is arranged for forming cuts so as to obtain at least one strap 27, 28 on the capsule 2.

The cutting apparatus 100 comprises, in particular, an unloading zone 60 positioned downstream of the cutting zone 50 in which the capsule 2 is unloaded, for example along an unloading direction S exiting the carousel 70, or is transferred to a subsequent machining zone (not shown) of the capsule 2.

In the specific embodiment of FIG. 17, the carousel 70 rotates around the axis R′ in a revolution direction indicated with T, a spindle 71 removes a capsule 2 from the feeding zone 40 and conveys the capsule 2 to the cutting zone 50. In the cutting zone 50, the spindle 71 rotates the capsule 2 whereas it contacts and penetrates the side wall 2 of the capsule 2 from one or more cutting edges of the device 1, thus making the plurality of cuts on the capsule 2.

Once the cutting zone 50 is traversed, the spindle 71 conveys the cut capsule 2 to the unloading zone 60 where the capsule abandons the carousel 70 to be transferred to the subsequent machining zone.

In the specific embodiment of the cutting apparatus 100 of FIG. 17, an anticlockwise rotation direction T of the carousel 70 and a clockwise rotation direction of the spindle 71 are shown, in a further embodiment that is not shown of the cutting apparatus, the rotation directions can be reversed with respect to those shown and the feeding area can be positioned in place of the unloading zone and vice versa. The rotation direction of the carousel 70 defines a travel direction E of the capsule in the cutting device 1 as disclosed below.

The cutting device 1 comprises, in particular, at least one plate body 30, 30′, 30″, 30′″ having a rectangular plan shape having two substantially flat faces that are opposite one another. The at least one plate body 30, 30′, 30″, 30′″ comprises a peripheral portion shaped as a half circle or crescent the centre of which is positioned on an axis that is transverse, in particular orthogonal, to one of the two faces outside the plate body. In particular, this centre can be on the rotation axis R′ of the carousel 70.

The cutting device 1 comprises, in particular, at least one cutting edge 31, 31′, 31″, 31′″ configured to perform the at least one cut on the capsule 2 whilst the capsule rolls on the at least one cutting edge 31, 31′, 31″, 31′″. The at least one cutting edge 31, 31′, 31″, 31′″ can be arranged on the peripheral portion of the at least one plate body 30, 30′, 30″, 30′″.

The at least one cutting edge 31, 31′, 31″, 31′″ is provided, in particular, with a capsule inlet 30a, 30a′, 30a″, 30a′″, where the capsule 2 meets the at least one cutting edge 31, 31′, 31″, 31′″ to start the at least one cut. In other words, the capsule inlet 30a, 30a′, 30a″, 30a′″ is arranged for forming the start cut on the capsule 2.

The at least one cutting edge 31, 31′, 31″, 31′″ is provided, in particular, with a capsule outlet 30b, 30b′, 30b″, 30b′″, where the capsule leaves the at least one cutting edge 31, 31′, 31″, 31′″ to end the at least one cut. In other words, the capsule outlet 30b, 30b′, 30b″, 30b′″ is arranged for forming the cut end on the capsule 2.

The at least one cutting edge 31, 31′, 31″, 31′″ comprises, in particular, at least one transition cutting portion 32, 32′, 32″, 32′″ arranged on the capsule inlet 30a, 30a′, 30a″, 30a′″ and/or on the capsule outlet 30b, 30b′, 30b″, 30b′″ to form at least one cusp-shaped end zone 24a, 24b, 24c, 24d at the cut start and/or the cut end.

The transition cutting portion 32, 32′, 32″, 32′″ is retracted with respect to a remaining part of the at least one cutting edge 31, 31′, 31″, 31′″ so as to penetrate at least one thickness of the capsule 2, in particular one thickness of the side wall 21, with respect to the remaining part of the at least one cutting edge 31, 31′, 31″, 31′″ so as to reduce the stress concentration and discourage the triggering of a fracture in the at least one cusp-shaped end zone 24a, 24b, 24c, 24d.

In other words, the position in which the transition cutting portion 32, 32′, 32″, 32′″ is retracted with respect to the remaining part enables part of the material of the capsule 2 to be left intact at the at least one cusp-shaped end zone 24a, 24b, 24c, 24d such that the cut start and/or the cut end do not excessively weaken the at least one strap 27, 28.

The transition cutting portion 32, 32′, 32″, 32′″ extends for an angular sector that is less than the remaining part of the at least one cutting edge 31, 31′, 31″, 31′″ such that most of the at least one cut, in particular the central part of the at least one cut, not affected by a concentration of the stress that is critical for the structure of the capsule 2, is made from the remaining part of the at least one cutting edge 31, 31′, 31″, 31′″.

The at least one cutting edge 31, 31′, 31″, 31′″ comprises, in particular, a wedge-shaped portion that extends on a median plane M, M′, M″, M′″. The wedge-shaped portion is provided with an end facing outside that defines a profile of the at least one cutting edge 31, 31′, 31″, 31′″. During performance of the cut, the at least one cutting edge penetrating at least partially the thickness of the capsule 2, in particular of the side wall 21, shows negatively the profile of the cutting edge on the cutting capsule making the at least one cut. The wedge-shaped portion is further provided with a base connected to the plate body 30, 30′, 30″, 30′″ on which the at least one cutting edge 31, 31′, 31″, 31′″ is obtained.

Similarly, also the at least one transition portion 32 and the remaining part of the cutting edge comprise respective wedge-shaped bodies like the one disclosed, which define a profile of the transition cutting portion 32 and a profile of the remaining part of the cutting edge 31.

With reference to the cross sections illustrated in FIGS. 2, 8, 13, the at least one transition cutting portion 32, 32′, 32″, 32′″ (or equivalently the at least one cutting edge 31, 31′, 31″, 31′″) can provide sharpening both on an upper side 32a, 32a′, 32a″ and on a lower side 32b, 32b′, 32b″, in particular, both the upper side 32a, 32a′, 32a″ and the lower side 32b, 32b′, 32b″ are tilted by a respective acute angle with respect to the median plane M, M′, M″, M′″ of the cutting edge 31, 31′, 31″, 31′″.

Alternatively, in a further embodiment, the at least one transition cutting portion 32, 32′, 32″, 32′″ can provide single sharpening, i.e. can be sharpened on one side. In other words, the upper side 32a, 32a′, 32a″ can be arranged parallel to the median plane M, M′, M″, M′″ and the lower side 32b, 32b′, 32b″ can be tilted by an acute angle with respect to the median plane M, M′, M″, M′″, or vice versa.

The transition cutting portion 32, 32′, 32″, 32′″ is in particular contiguous with the remaining part of the at least one cutting edge 31, 31′, 31″, 31′″ so that the at least one cutting edge 31, 31′, 31″, 31′″ makes the at least one cut continuously.

The profile of the at least one transition cutting portion 32, 32′, 32″, 32′″ and the profile of the remaining part of the transition cutting edge 31, 31′, 31″, 31′″ lie on the same plane, in particular on the median plane M, M′, M″, M′″.

The cutting device 1 can comprise, in particular, a layer structure comprising at least two plate bodies 30, 30′, 30″, 30′″ stacked on one another in a stacking direction that is transverse, in particular orthogonal, to at least one face of one of the at least two plate bodies 30, 30′, 30″, 30′″, so as to make an arrangement of cutting edges, in which at least two cutting edges 31, 31′, 31″, 31′″ are arranged on at least two distinct levels along the stacking direction for cutting the capsule 2 for forming the at least one strap 27, 28.

In one alternative embodiment, the cutting device 1 can comprise, in particular, a single cutting plate-formed element that comprises at least two cutting edges 31, 31′, 31″, 31′″ arranged on at least two distinct levels along a direction parallel to a thickness of the single plate-shaped element for forming the at least one strap 27, 28 on the capsule 2.

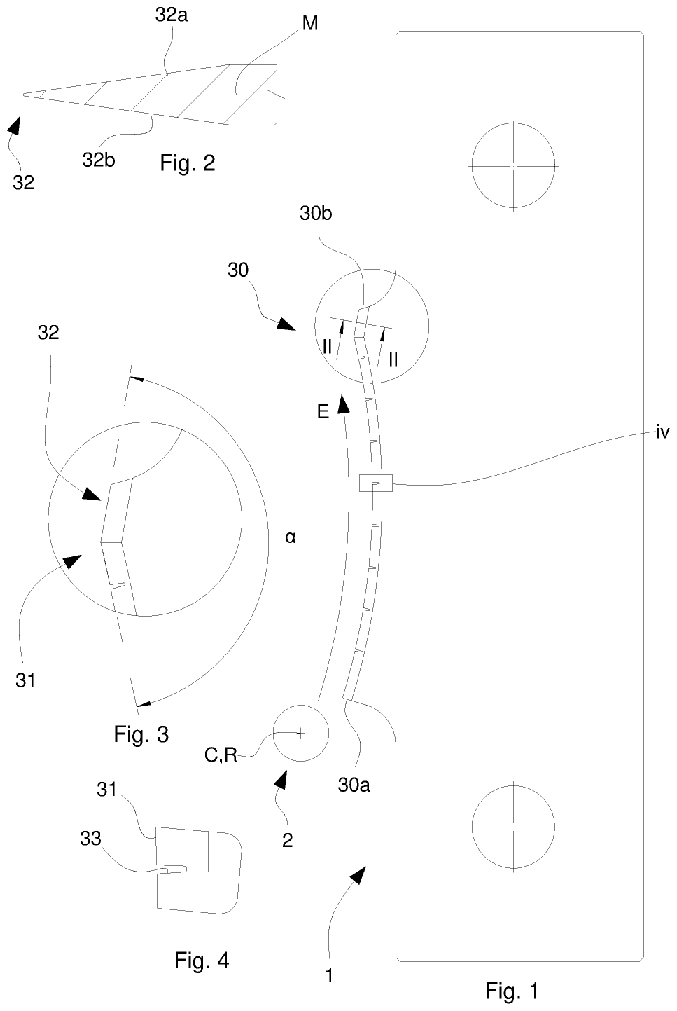

With reference to the specific embodiment shown in FIGS. 1 to 4, the transition cutting portion 32 is arranged on the capsule outlet 30b. Again with reference to the specific embodiment of FIG. 1, the cutting device 1 comprises a cutting edge, however, a cutting device can be provided comprising more than one cutting edge spaced apart from one another along the travel direction E so as to generate more cuts. Each cut edge can comprise a respective transition cutting portion.

In the specific embodiment of FIG. 1 and FIG. 3, the transition cutting portion 32 is tilted with respect to the remaining part of the cutting edge 31 so as to form an obtuse angle α between the transition cutting portion 32 and the remaining part of the cutting edge 31. In particular, the angle α is inside the cutting edge 31, lies on a plane parallel to the median plane M (or equivalently to the drawing plane of FIG. 3) and is centred in a point positioned between the transition cutting portion 32 and the remaining part of the cutting edge 31 in which the cutting edge 31 changes incline.

The remaining part of the cutting edge 31 has an at least partially curved, in particular partially circumference arc profile, in which the circumference arc is centred on an axis outside the cutting device 1 and orthogonal to the median plane M. In particular, this circumference arc can be centred on the rotation axis R′ of the carousel 70. In a further embodiment that is not illustrated, the remaining part of the cutting edge 31 can have an at least partially rectilinear profile.

In the specific embodiment of FIGS. 1 and 3, the transition cutting portion 32 has an at least partially rectilinear profile. Nevertheless, in a further embodiment that is not illustrated, the transition cutting portion 32 can have an at least partially curved profile.

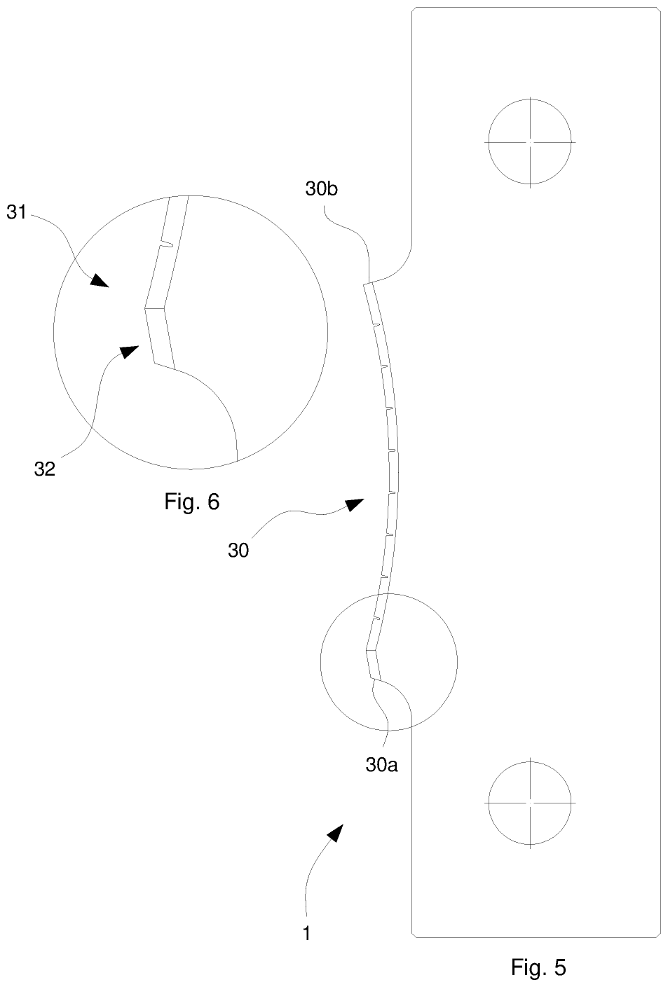

The specific embodiment shown in FIGS. 5 and 6 is a version of the embodiment of FIG. 1, in which the transition cutting portion 32 is arranged on the capsule inlet 30a.

Referring again to FIG. 1, the capsule 2 is arranged to rotate on itself, in particular around the longitudinal axis C coaxial with the rotation axis R of the spindle 71. In a further embodiment, that for the sake of simplicity that is not illustrated, it is possible for the longitudinal axis C of the capsule 2 and the rotation axis R of the spindle 71 not to be coaxial but spaced apart from one another.

With reference to the specific embodiment of FIGS. 7, 8 and 9, the transition cutting portion 32′ is arranged on the capsule inlet 30a′ and is retracted with respect to the remaining part of the cutting edge 31′ so as to form a step between the transition cutting portion 32′ and the remaining part of the cutting edge 31′.

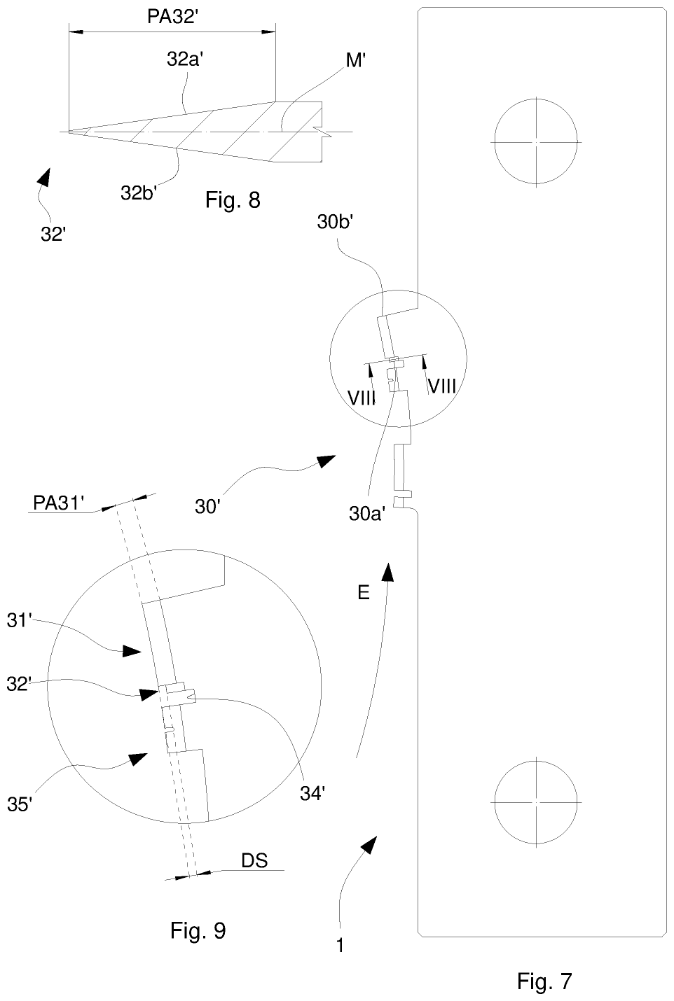

With reference in particular to FIG. 8, in which a section is shown that is taken along a plane that is perpendicular to the median plane M′ and perpendicular to the profile of the transition cutting portion 32′, a sharpening depth PA32′ can be defined that corresponds to a distance between the end of the wedge-shaped body (or equivalently the profile of the cutting portion 32′) and the base of the wedge-shaped body measured on the median plane M′ perpendicularly to the profile of the transition cutting portion 32′. Similarly, a sharpening depth PA31′ can be defined for the remaining part of the cutting edge 31′.

With reference now to FIG. 9, the transition cutting portion 32′ is moved away by an offset distance to the inside of the cutting edge 31 with respect to the remaining part of the cutting edge 31′. An offset distance DS between the transition cutting portion 32′ and the remaining part of the cutting edge is comprised between ⅕ and ½, in particular ⅓, of the sharpening depth PA31′ of the remaining part of the cutting edge 31′.

With reference to FIGS. 7, 9, 10 and 11, the cutting device 1 further comprises at least one further cutting edge 35′ to perform a further cut on the capsule 2, the at least one further cutting edge 35′ is spaced away from the cutting edge 31′ by a non-cutting recess 34′ that is contiguous with the cutting edge 31′ and with the further cutting edge 35′. During performance of the cut, when the capsule rolls on the cutting edge 31′, the recess 34′ does not contact the capsule 2. The at least one further cutting edge 35′ can lie on the same plane as the at least one cutting edge 31′″, in particular on the median plane M′. The further cutting edge 35′ can have an at least partially curved profile, in particular at least partially circumference arc (FIGS. 7, 9, 10, 11) profile. In a further embodiment that is not illustrated the further cutting edge 35′ can have an at least partially rectilinear profile. The cutting device 1 can comprise, in particular, cutting edges 35′ that are spaced apart from one another and from the cutting edges 31′ by recesses 34′ so as to perform several distinct cuts on the capsule 2.

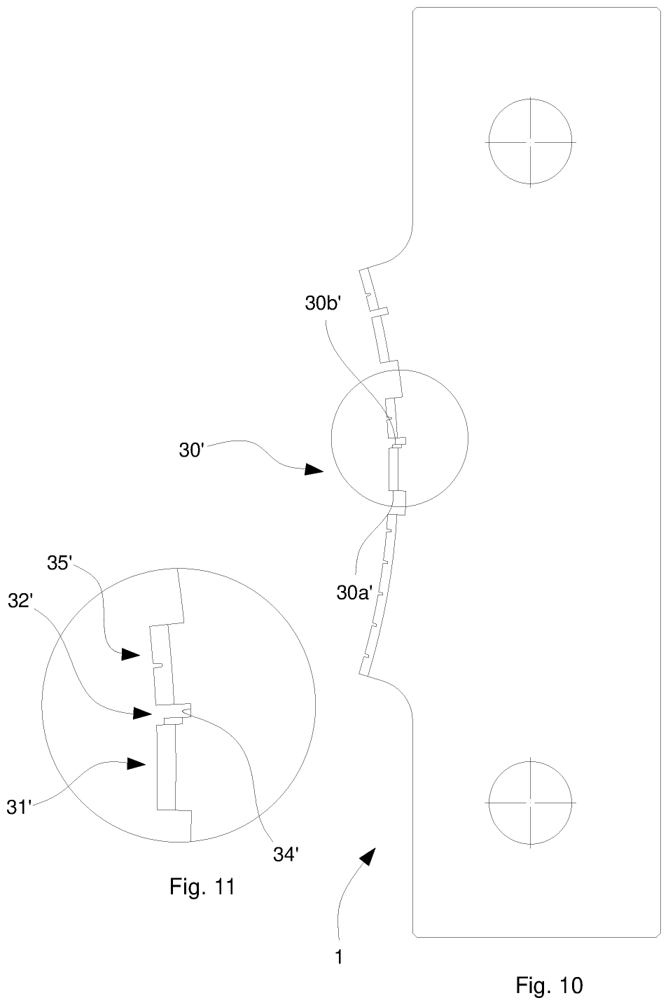

The specific embodiment shown in FIGS. 10 and 11 is a version of the embodiment of FIG. 7, in which the transition cutting portion 32′ is arranged on the capsule outlet 30b′.

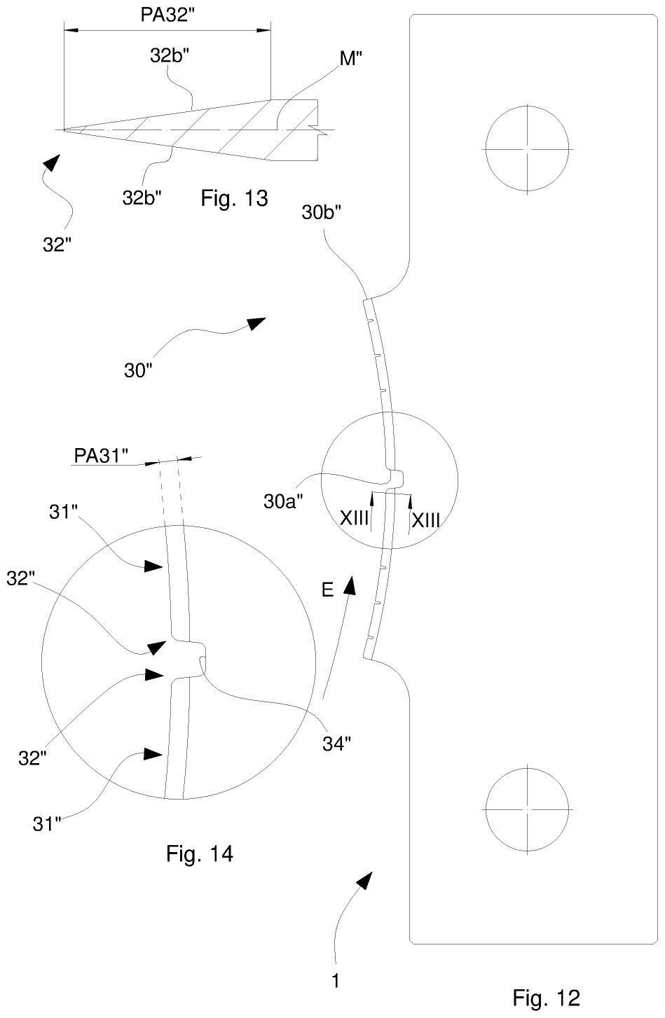

In the specific embodiment of FIGS. 12, 13 and 14, the transition cutting portion 32″ is connected to the remaining part of the transition cutting edge 31″ and has a curved, in particular at least partially circumference arc profile, in a plane parallel to the median plane M″. In other words, the profile of the transition cutting portion 32″ is contiguous to the profile of the remaining part of the cutting edge 31″ and enters by curving towards the inside of the cutting edge 31″. A curvature radius of the profile of the transition cutting portion 32″ can be comprised between 0.3 and 2 times, in particular 0.5 times, the sharpening depth PA31″ of the cutting edge 31″.

With reference in particular to FIGS. 12 and 14, the plate body 30″ comprises a first and a second cutting edge 31″ for forming the two upper cusp end zones 24a, 24b of said at least one strap 27, 28. The two cutting edges 31″ lie on the same median plane M″ and are spaced apart from one another along the travel direction E. In the first cutting edge 31″, a first transition cutting portion 32″ is arranged on the capsule inlet 30a″, in the second cutting edge 31″ a second transition cutting portion 32″ is arranged on the capsule outlet 30b″ so that the two curved transition cutting portions 32″ face one another.

The two transition cutting portions 32″ are separated by a further recess 34″ so as to perform two distinct cuts on the capsule 2.

As shown in FIGS. 12 and 14, the remaining part/s of the at least one cutting edge 31″ can be at least partially curved, in particular at least partially a circumference arc the centre of which arranged outside the cutting device 1.

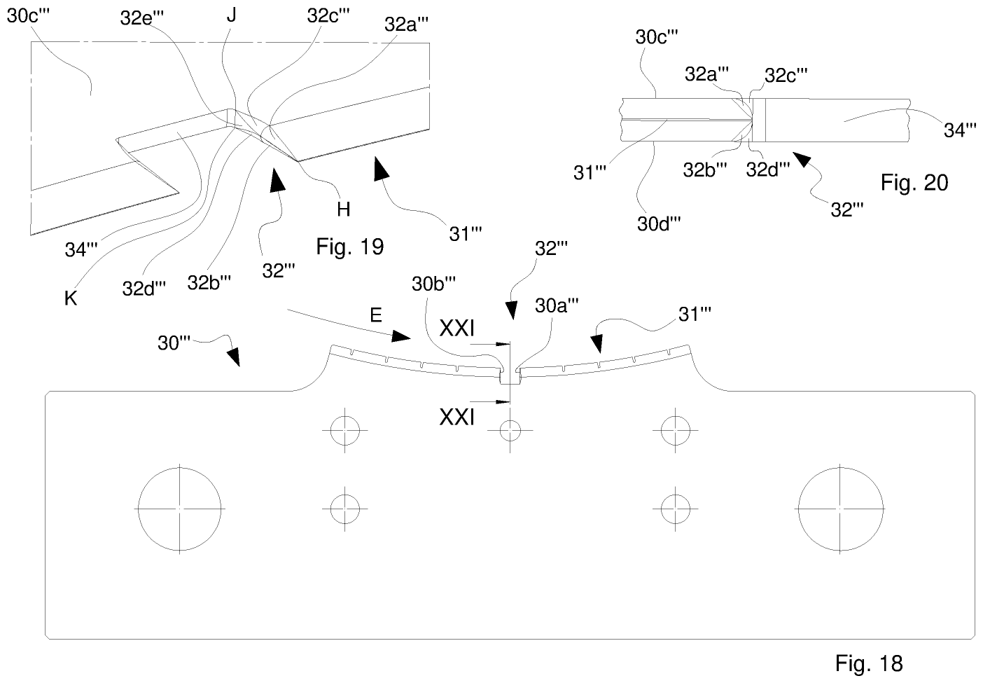

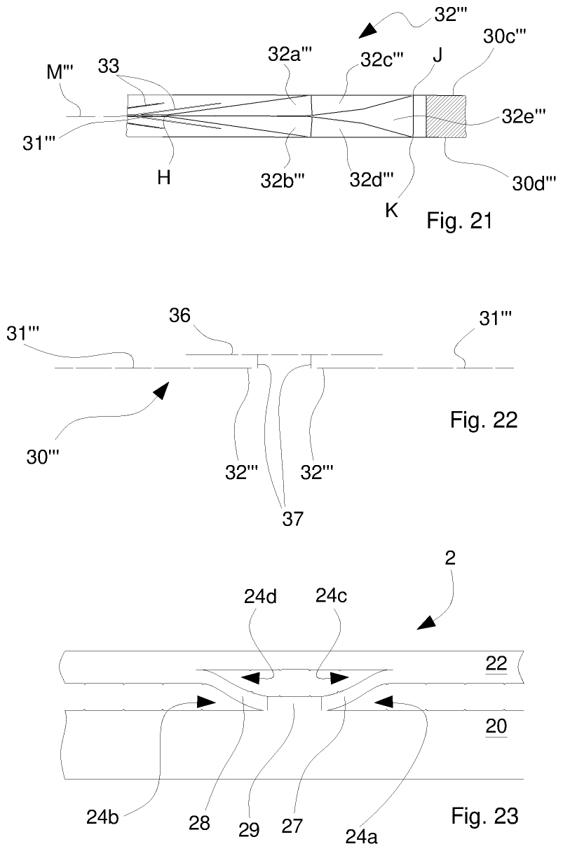

In the specific embodiment of FIGS. 18, 19, 20 and 21, the transition cutting portion 32′″ is rounded (or blunt) and comprises, in particular, at least one curve surface 32a′″, 32b′″ configured, in particular, to cut the capsule 2 at the cut start and/or the cut end. In FIGS. 18, 19, 20 and 21, two curve surfaces 32a′″, 32b′″ are indicated: an upper curve surface 32a″ and a lower curve surface 32b′″ which are substantially symmetric with respect to the median plane M′″. The curve surfaces 32a′″ and 32b′″ can be connected to each other to form a single curve surface.

The at last one curve surface 32a′″, 32b′″ is curved in at least one direction transverse to the median plane M′″ of the at least one cutting edge 31′″ along which the at least one cut is performed. The at last one curve surface 32a′″, 32b′″ can be cone shaped, in particular semi-cone shaped (as in the illustrated embodiment). A peak H of the cone can be obtained at the remaining part of the cutting edge 31′″ (or equivalently at the profile of the remaining part of the cutting edge 31′″).

In the specific embodiment of FIGS. 18, 19, 20 and 21, the plate body 30′″ comprises a first and a second cutting edge 31′″ for forming the two upper cusps end zones 24a, 24b of the straps 27, 28. The two cutting edges 31′″ lie on the same median plane M′″ and are spaced apart from one another along the travel direction E. In the first cutting edge 31′″, a first transition cutting portion 32′″ is arranged on the capsule inlet 30a′″, in the second cutting edge 31′″ a second transition cutting portion 32′″ is arranged on the capsule outlet 30b′″ so that the two transition cutting portions 32′″ face one another. The two transition cutting portions 32′″ are separated by a further recess 34′″ so as to perform two distinct cuts on the capsule 2.

The plate body 30′″ (FIGS. 19, 20 and 21) is provided with an upper face 30c′″ and a lower face 30d′″ opposite to each other. The upper face 30c′″ and the lower face 30d′″ are substantially flat and substantially parallel to each other.

The cutting device 1 (according to the embodiment of FIGS. 18, 19, 20 e 21) can comprise at least one base surface 32c′″, 32d′″ configured to connect the at least one curve surface 32a′″, 32b′″ to the base of said at least one cutting edge 31′″. The at least one base surface 32c′″, 32d′″ can be curved. In the illustrated embodiment, an upper base surface 32c′″ to connect the at least curve surface 32a′″, 32b′″ to the upper face 30c′″ and a lower base surface 32d′″ to connect the at least curve surface 32a′″, 32b′″ to the lower face 30d′″ are provided. In the illustrated embodiment, the at least one base surface 32c′″, 32d′″ is arranged near the further recess 34′″. Between the two base surfaces 32c′″, 32d′″ an intermediate connecting surface 32e′″ can be provided, which can be substantially flat. The upper base surface 32c′″ (or the lower base surface 32d′″) can be triangular sail shaped, or a semi-cone shaped, which ends in an upper peak zone J (or in a lower peak zone K) at the upper face 30c′″ (or at the lower face 3d′″).

Referring to the embodiment of FIG. 22, the cutting device 1 provides two cutting edges 31′″ on a same height, which are spaced apart by the non-cutting further recess 34′″. The two cutting edges 31′″ are provided with respective transition cutting portions 32′″ for forming the two upper cusps end zones 24a, 24 (FIGS. 15 and 23). The cutting device 1 can comprise a horizontal cutting edge 36 arranged at an height that is different with respect to the height of the two cutting edges 31′″. Referring to FIG. 22, the cutting device 1 comprises, in particular, a layered structure of more (three) plate bodies stacked on top of each other for forming a cutting edges arrangement suitable for forming the straps 27, 28 (FIGS. 22 and 23). The cutting device 1 comprises, in particular, one or more (two) transverse cutting edges 37 for forming transverse cuts on the capsule 2. In the embodiment illustrated in FIGS. 22 and 23, the transverse cuts can define a tab portion 29 (FIG. 23) on the cap 2 which is suitable for interacting with the tamperproof ring 22 (or with a protrusion on a containers neck) to maintain the capsule body 20 in a tilted position after opening the container. The one or more transverse cutting edges 37 can be obtained on an edge of a further plate body (not shown). The one or more transverse cutting edges 37 can comprise vertical cutting edges, i.e. orthogonal to the median plane M′″ (as in FIG. 22), and/or one or more tilted cutting edges (not shown) which are tilted with respect to the median plane M′″.

The transition cutting portion 32′″, owing to the structure thereof allows to form a curved cut (or a curved perforation) in the thickness of the capsule 2 at the start of the cut and/or the end of the cut so as to reduce the concentration of stresses and prevent the initiation of a fracture in the at least one cusp end zone 24a, 24b, 24c, 24d. In particular, the curved surface 32a′″, 32b′″ is effective in forming the upper cusp end zones 24a, 24b. The upper cusp end zones 24a, 24b can be obtained in the capsule 2 near the cuts intended to form the tab portion 29 (FIG. 23).

The cutting device 1 can comprise, in particular, at least one recess 33 (FIG. 4) arranged on the at least one cutting edge 31, 31′, 31″, 31′″ for forming on the capsule 2 at least one bridge, a thread-shaped connecting portion between the tamperproof ring 22 and the main body 20 intended to be broken at the opening of the container to which the capsule 2 is applied so as to show a user that the container has opened. After opening of the container, the capsule 2 looks like the one shown in FIG. 15 provided with a portion of broken bridge 26 arranged on the open end of the main body 20. The at least one recess 33 has dimensions that are reduced with respect to the recess 34′ (and with respect to the further recess 34″) so as to create a section of the bridge that is noticeably less than a section of the at least one strap 27, 28. In fact, the connection of the at least one bridge between the tamperproof ring 22 and the main body 20, being arranged to be interrupted once the container is open, requires less mechanical resistance than that of the at least one connecting strap 27, 28.

As can be seen from what has been disclosed above, the cutting device 1 according to the present invention enables the limits and drawbacks of the devices of the prior art to be overcome. The cutting device 1 according to the invention is particularly useful for forming connecting straps with a mechanical quality and resistance that are greater than known cutting devices. This is owing to at least one transition cutting portion that enables the size of the cut in the thickness of the capsule to be reduced to at least one cusp-shaped end zone of the cut, thus reducing the concentration of the stress that can lead to the triggering of a fracture in the connecting straps and in the capsule.

1. Cutting device for forming at least one connecting strap on a container closing capsule to keep said capsule attached to container after opening, said cutting device comprising at least one cutting edge configured to perform at least one cut on said capsule, said capsule rolling on said at least one cutting edge during performing of said at least one cut with a cut start and a cut end to form at least a part of said at least one connecting strap, said at least one cutting edge being provided with a capsule inlet where said capsule meets said at least one cutting edge to start said at least one cut, and with a capsule outlet where said capsule leaves said at least one cutting edge to end said at least one cut, said at least one cutting edge including at least one transition cutting portion arranged on said capsule inlet and/or on said capsule outlet to form at least one cusp-shaped end zone at said cut start and/or at said cut end, said at least one transition cutting portion being arranged backward with respect to a remaining part of said at least one cutting edge so as to penetrate less a thickness of said capsule with respect to said remaining part of said at least one cutting edge to reduce stress concentration and prevent initiation of a fracture in said at least one cusp-shaped end zone, wherein said at least one transition cutting portion is retracted with respect to said remaining part of said at least one cutting edge to provide a step between said at least one transition cutting portion and said remaining part of said at least one cutting edge.

2. Cutting device according to claim 1, wherein said at least one transition cutting portion is contiguous to said remaining part of said at least one cutting edge thereby that said at least one cutting edge continuously performs said at least one cut.

3. Cutting device according to claim 1, comprising a layered structure with at least two plate bodies stacked on top of each other to form an arrangement of cutting edges configured to cut said capsule to form said at least one strap.

4. Cutting device according to claim 1, wherein a cross section of said remaining part of said at least one cutting edge is equal to a cross section of said at least one transition cutting portion, said cross sections being on section planes perpendicular to said at least one cutting edge.

5. Cutting device according to claim 1, wherein said at least one transition cutting portion is inclined with respect to said remaining part of said cutting edge so that an angle between said transition cutting portion and said remaining part of said at least one cutting edge is obtuse; said at least one transition cutting portion comprising a rectilinear portion.

6. Cutting device according to claim 1, wherein said at least one transition cutting portion is joined to said remaining part of said at least one cutting edge, said at least one transition cutting portion being curved; said at least one cutting transition portion comprising a circumference arc.

7. Cutting device according to claim 1, wherein said at least one transition cutting portion comprises a straight portion.

8. Cutting device according to claim 1, further comprising at least one further cutting edge for performing a further cut on said capsule, said at least one cutting edge being spaced from said at least one further cutting edge by a non-cutting recess so that said at least one cut is distinct from said further cut said cutting device further comprising two transitional cutting portions separated by a further recess to form two cusp-shaped end zones of said at least one strap.

9. (canceled)

10. Cutting device according to claim 1, wherein said at least one transition cutting portion and said remaining part of said cutting edge lie on one same plane.

11. Cutting device for forming at least one connecting strap on a container closing capsule to keep said capsule attached to container after opening, said cutting device at least one cutting edge configured to perform at least one cut on said capsule, said capsule rolling on said at least one cutting edge during performing, of said at least one cut with a cut start and a cut end to form at least a part of said at least one connecting strap, said at least one cutting edge being provided with a capsule inlet where said capsule meets said at least one cutting edge to start said at least one cut, and with a capsule outlet where said capsule leaves said at least one cutting edge to end said at least one cut, said at least one cutting edge including at least one transition cutting portion arranged on said capsule inlet and/or on said capsule outlet to form at least one cusp-shaped end zone at said cut start and/or at said cut end, said at least one transition cutting portion being arranged backward with respect to a remaining part of said at least one cutting edge so as to penetrate less a thickness of said capsule with respect to said remaining part of said at least one cutting edge to reduce stress concentration and prevent initiation of a fracture in said at least one cusp-shaped end zone, wherein said at least one transition cutting portion is rounded, said at least one transition cutting portion comprising at least one curve surface configured to cut said capsule at said cut start and/or said cut end, said at least one curve surface being curved in at least one direction transverse to a median plane.

12. (canceled)

13. Cutting device according to claim 11, wherein said at least one curve surface is cone shaped, in particular semi-cone shaped, a peak of said cone being obtained at said remaining part of said at least one cutting edge.

14. Cutting device according to claim 13, wherein at least one base surface configured to connect said at least one curve surface to a base of said at least one cutting edge is provided, wherein said at least one cutting edge is obtained on a peripheral edge of a plate body said plate body being provided with an upper face and a lower face opposite to each other; and wherein at least one upper base surface connects said at least one curve surface to said upper face and at least one lower base surface connects said at least one curve surface to said lower face.

15. Cutting device according to claim 11, wherein said at least one transition cutting portion is contiguous to said remaining part of said at least one cutting edge thereby that said at least one cutting edge continuously performs said at least one cut.

16. Cutting device according to claim 11, comprising a layered structure with at least two plate bodies stacked on top of each other to form an arrangement of cutting edges configured to cut said capsule to form said at least one strap.

17. Cutting device according to claim 11, wherein a cross section of said remaining part of said at least one cutting edge is equal to a cross section of said at least one transition cutting portion, said cross sections being on section planes perpendicular to said at least one cutting edge.

18. Cutting device according to claim 11, wherein said at least one transition cutting portion is inclined with respect to said remaining part of said cutting edge so that an angle between said transition cutting portion and said remaining part of said at least one cutting edge is obtuse; said at least one transition cutting portion comprising a rectilinear portion, wherein said at least one transition cutting portion is joined to said remaining part of said at least one cutting edge, said at least one transition cutting portion being curved said at least one cutting transition portion comprising a circumferential arc.

19. (canceled)

20. Cutting device according to claim 11, wherein said at least one transition cutting portion is retracted with respect to said remaining part of said at least one cutting edge to provide a step between said at least one transition cutting portion and said remaining part of said at least one cutting edge, said at least one transition cutting portion comprising a straight portion.

21. Cutting device according to claim 11, comprising at least one further cutting edge for performing a further cut on said capsule said at least one cutting edge being spaced from said at least one further cutting edge by a non-cutting recess so that said at least one cut is distinct from said further cut, said cutting device further comprising two transitional cutting portions separated by a further recess to form two cusp-shaped zones of said at least one strap.

22. (canceled)

23. Cutting device according to claim 11, wherein said at least one transition cutting portion and said remaining part of said cutting edge lie on one same plane.

24. Cutting apparatus for forming at least one connecting strap on a capsule for closing a container to keep said capsule attached to said container after opening, said cutting apparatus comprising:
a feeding zone into which said capsule to be cut is fed;
a cutting zone downstream of said feeding zone in which said capsule is cut, where “downstream” is intended with reference to a path of advancement of said capsule;
an unloading zone downstream of said cutting zone in which said capsule is unloaded or transferred to a subsequent processing zone;
one or more cutting devices according to claim 1 arranged in said cutting zone to form at least one strap on said capsule;
a carousel for capsules comprising a plurality of mandrels mounted angularly spaced apart on a periphery of said carousel, each mandrel being arranged to engage with a capsule, to rotate said capsule on itself and transporting said capsule along said advancement path through said feeding zone, said cutting zone and said unloading zone.

25. Cutting apparatus for forming at least one connecting strap on a capsule for closing a container to keep said capsule attached to said container after opening, said cutting apparatus comprising:
a feeding zone into which said capsule to be cut is fed;
a cutting zone downstream of said feeding zone in which said capsule is cut, where “downstream” is intended with reference to a path of advancement of said capsule;
an unloading zone downstream of said cutting zone in which said capsule is unloaded or transferred to a subsequent processing zone;
one or more cutting devices according to claim 11 arranged in said cutting zone to form at least one strap on said capsule;
a carousel for capsules comprising a plurality of mandrels mounted angularly spaced apart on a periphery of said carousel, each mandrel being arranged to engage with a capsule, to rotate said capsule on itself and transporting said capsule along said advancement path through said feeding zone, said cutting zone and said unloading zone.
